(19) United States
(12) Patent Application Publication
(10) Pub. No.: US 2007/0039567 A1
(43) Pub. Date: Feb. 22, 2007

(54) Apparatus to collect dog faeces

(76) Inventor: Luis Eduardo Osimani De Fuentes, Montevideo (UY)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/439,909

(22) Filed: May 24, 2006

(30) Foreign Application Priority Data
May 24, 2005 (UY) U - 4064

(51) Int. Cl. A01K 23/00

(52) U.S. Cl. 119/869

(57) ABSTRACT

An apparatus for the collection of dog faeces comprising a tube with the near end curved in order for it to be taken by the hand and with a loop, with a top which can be moved by means of a spring joined to the loop by means of a hinge system and operated by a cable from the hand end on which a bag is fitted to receive the faeces before they fall to the ground.

### BACKGROUND OF THE INVENTION

1. Field of the Invention

The present invention relates to the technical area for the non-automatic collection of dog faeces, providing a clean and easy to use solution to the problem of the collection of dog faeces on public pathways.

2. Description of Related Art

The applicant is aware of several solutions designed to resolve the same problem. These go from the simple use of a plastic bag held in the owners hand to different types of spades and pincers to pick up the faeces once these have been deposited on the public pathway, green areas or areas for recreation, etc.

By way of example the applicant is aware of a device to collect dog faeces as per the following drawing, which refers to a special type of pincer with a receiving bag attached, as shown in FIGS. 1-3.

In addition the applicant is aware of a device to retain excrement (a drawing is attached so it can be better understood) which is for use particularly with dogs, which retains the dog faeces prior to them falling onto the ground, as shown in FIGS. 4-6.

In addition the inventor is aware of a disposable device to pick up dog faeces consisting of a case, as per the drawing, as shown in FIGS. 7A-7C.

Finally the inventor is also aware of the design shown in FIGS. 8A-8B.

In conclusion the inventor does not know of any pre-existing devices which have the characteristics and advantages of that which is set out below.

### SUMMARY OF THE INVENTION

The subject matter of the present invention is a portable device for the collection of dog faeces before they fall to the ground. It has two fundamental characteristics which relate to the aim of the invention: with regard to the protection of the environment, the configuration of the device avoids the negative environmental, social and sanitary effects caused by the existence of dog faeces on public pathways, because the faeces are collected before they fall to the ground and secondly as regards the user, who does not have to make physical contact with the faeces.

An apparatus for the collection of dog faeces comprising a tube with the near end curved in order for it to be taken by the hand and with a loop, with a top which can be moved by means of a spring joined to the loop by means of a hinge system and operated by a cable from the hand end on which a bag is fitted to receive the faeces before they fall to the ground.

The problem of canine faeces in public areas has negative consequences in several different respects: environmental, social and sanitary. With regard to environmental contamination, faeces on public pathways make a city look ugly, making it look uncared for and unhygienic. At the same time the characteristic smell of faeces is unpleasant and bothersome to people and if faeces are left on public areas they are a source of contamination from diseases spread by dogs. The advantages that the present invention has with regard to the problems briefly described are as follows: 1) It is ecological, insofar as it avoids dirtying the pavement and public areas with the dogs faeces. 2) No effort needs to be made to collect faeces which could be spread over a large areas and/or on irregular terrain, so that it is difficult to properly collect them. 3) If the dog has a case of diarrhoea and the faeces are more liquid then it is much easier to collect such and leave the floor clean. 4) The device can be used with one hand only. This is relevant when the other hand is being used to hold the dog on a lead. In such cases it can be very difficult to manoeuvre oneself to collect the faeces using either the spade or pincer devices, since such require the use of both hands and normally at that moment in time the dog will pull on the lead in order to continue its walk, thus making the task harder. 5) The system is totally hygienic because at no time do the faeces come into contact with the human hand or with the apparatus itself, save for contact with the bag when it is being disposed of. This system therefore avoids the unpleasant situation of having to collect the faeces from the floor using ones hand in a plastic bag or pushing it towards a plastic bag using a spade, broom or pincer, and the like because these are collected before they fall to the ground. The system therefore provides a practical and hygienic solution to the problem.

With regard to the form of carrying out the invention in practice and also the way in which such can be exploited industrially, this is evident from the description given and from the nature of the device itself.

### BRIEF DESCRIPTION OF THE DRAWINGS

In order to complete the description of the device and in order to provide a better understanding of its characteristics, and as an integral part of the description, but without limiting such, attached are a set of drawings by way of illustration, in which the following are shown:

FIGS. 1-3 are schematic diagrams of a prior art device.

FIGS. 4-6 are schematic diagrams of a prior art device.

FIGS. 7A-7C are schematic diagrams of a prior art device.

FIGS. 8A and 8B are photographs of a prior art device.

FIG. 9 is a perspective view of a portion of the apparatus;

FIG. 10A is a schematic diagram of the apparatus.

FIG. 10B is a plan view of the loop and top of the apparatus.

FIG. 10C is a plan view of the tube.

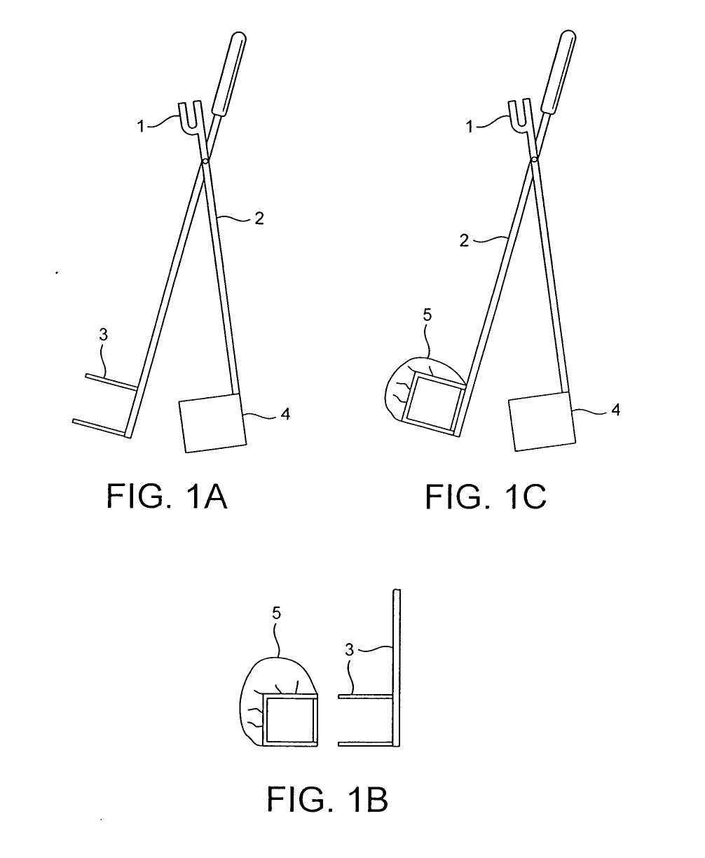

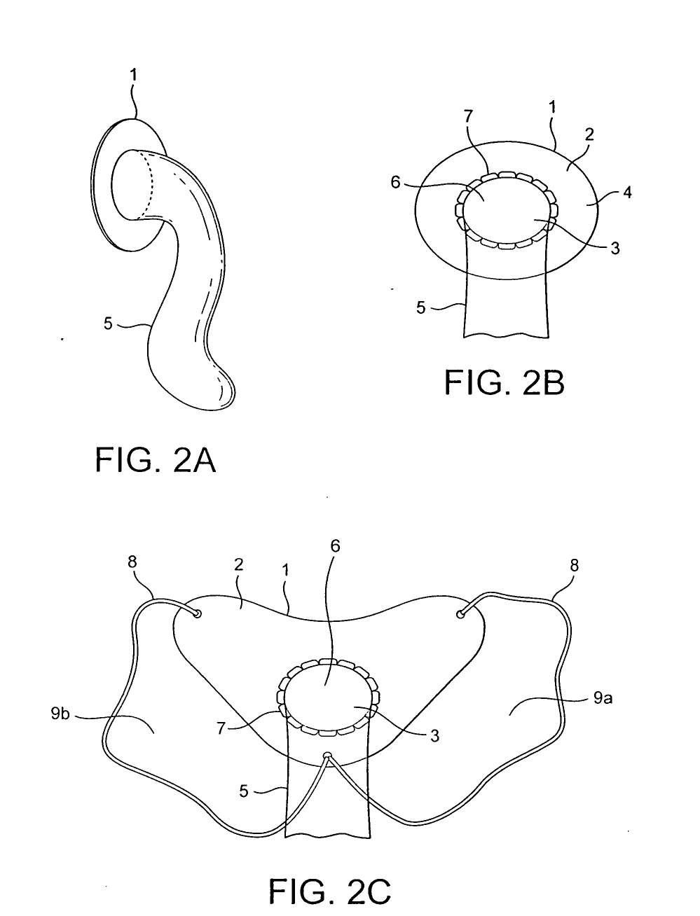

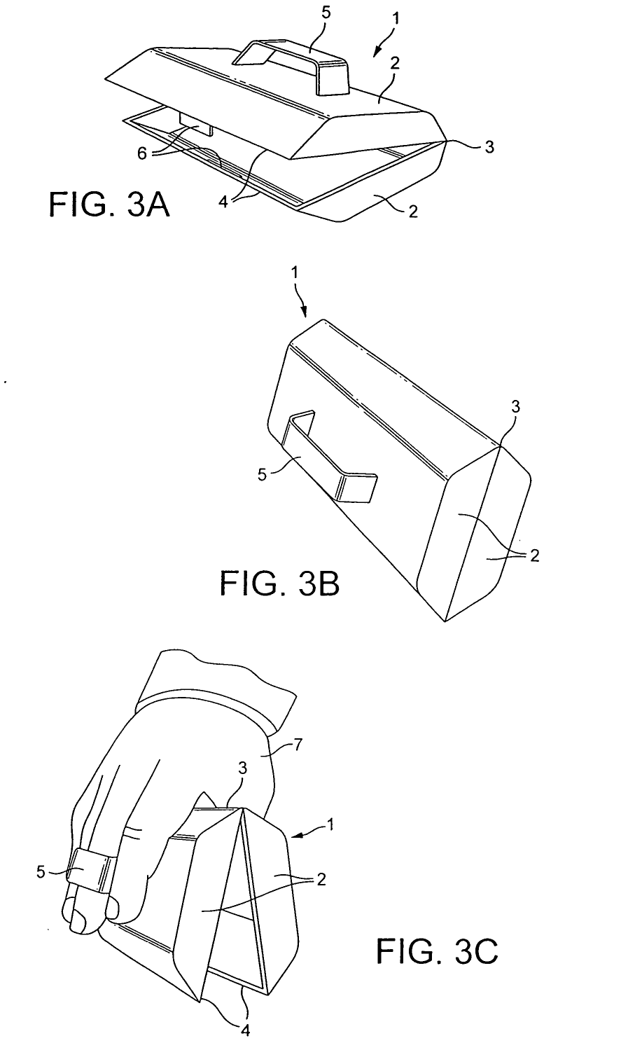

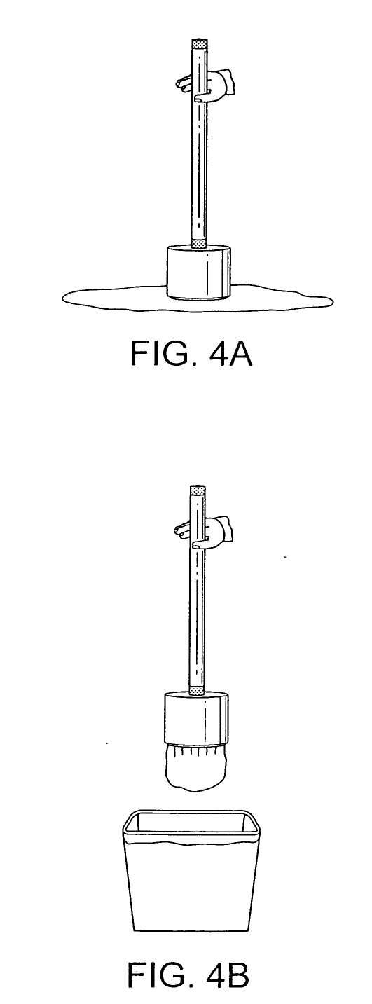

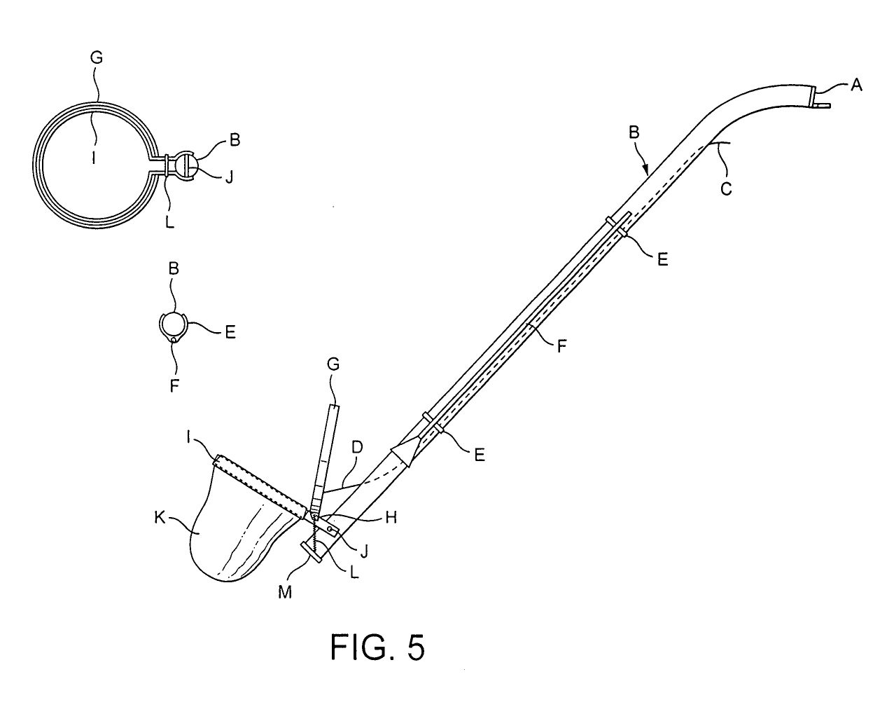

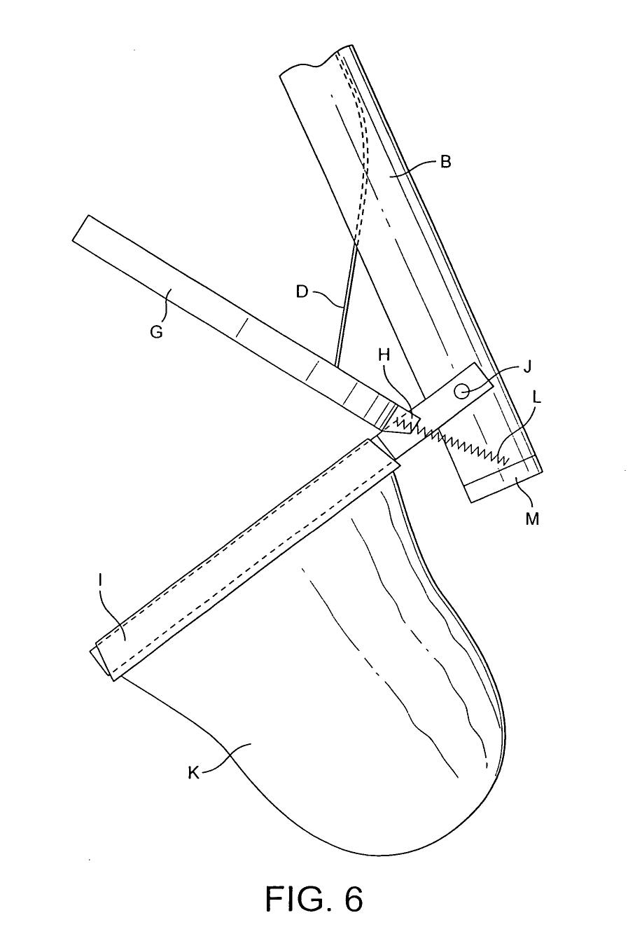

The invention will be more fully described by reference to the following drawings.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

Apparatus 10 comprises tube 12, approximately 68 centimetres in length, with the near end 11 curved to hold in the hand and at the other end 13 loop 12, approximately 12 centimetres in diameter joined to tube 12 by rivets 16, and bag 18 fitted to loop 14 for the collection of faeces, as shown in FIGS. 9 and 10. When the dog needs to defecate, the person puts loop 14 in the area where the faeces will fall so that the faeces will fall into bag 18 rather than onto the ground. Apparatus 10 has a type of top 20 for loop 14 which is retractable by means of spring 22, joined with loop 14 by means of hinge 24 and which can be operated by means of cable 26 in the handle. Cable 26 travels through the interior of tube 12 from the top 20, entering by way of orifice 21 adjacent to top 20 and exiting at end 23 together with the handle where when loop 28 is added it works substantially as a trigger which on pulling raises top 20.

Top 20 has three functions: 1) it means that the faeces collected remain out of sight, 2) it stops the smell of the faeces collected from spreading and 3) it maintains bag 18 in position against loop 12, since if it did not have any means of support there would be a risk of it flying away when empty or falling when it is full. At the same time the fact that bag 18 has top 20 means that bag 18 can be used several times during the same walk, without it being necessary to use a new bag every time the dog defecates. In order to dispose of bag 18 it is only necessary to raise top 20 and using ones hand release bag 18 from hook 25 on loop 14 and let it fall or make a more abrupt movement with the handle end of apparatus 10 so that bag 18 is released and falls on its own.

Tube 12 and bar 32 can be aluminium or plastic. Top 20, loop 14, loop 18, top 30a and 30b, and spatula 34 can be plastic. Bag 18 can be formed of nylon.

At ends of tube 12 there are tops 30a and 30b to provide a proper finish to apparatus 10, and in which top 30b has a loop to be used to hang up apparatus 10 when not in use. Apparatus 10 has an accessory which can be used in cases of emergency when for some reason the faeces have not fallen into the bag. It comprises bar 32, approximately 35 centimetres long and 5 millimetres in diameter, with the further end from the handle in the form of spatula 34 in a triangular form, measuring approximately 3 centimetres each side, which is joined to tube 12 by means of two removable suction devices 36 which allow bar 32 to be removed and replaced according to the need for its use. If the faeces have fallen then bar 32 is removed and bar 32 is used as a sort of broom to assist in placing the faeces in the bag. However given the practicality of apparatus 10 and its easy useage, this part of the device will only be used in exceptional circumstances.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An apparatus for the collection of dog faeces, intended to be used for the collection of such prior to them falling to the ground, comprising a tube with the near end curved in order to be held in the hand and at the far end a loop joined to the tube by the loop one fits a bag for collection of the faeces.

2. The apparatus for the collection of dog faeces in accordance with claim 1 comprising a top for the loop which is retractable by means of a spring, joined to the loop by means of a hinge system which is operated by means of a cable from the handle which travels through the interior of the tube from the top, entering by way of an orifice which is close to the top and which exits at the handle end, which acts as a trigger by the addition of a second loop and thereby lifts the top.

3. The apparatus for the collection of dog faeces according to claim 1, wherein said apparatus prevents the faeces from being visible, avoiding the spreading of the smell of the faeces once collected and maintaining the bag together with the loop.

4. The apparatus for the collection of dog faeces according to claim 1, comprising an accessory of a bar with a spatula at the far end in a triangular shape which is attached to the tube by means of a pair of removable suction devices which enables the bar to be removed and replaced as necessary.

5. The apparatus for the collection of dog faeces in accordance with claim 1 wherein said loop is joined to said tube with rivets.
